(19) United States
(12) Patent Application Publication
(10) Pub. No.: US 2013/0042464 A1
(43) Pub. Date: Feb. 21, 2013

(54) Suspension enhancement retrofit mounting bushing and methods

(71) Applicant: Troy Wayne Orcutt, Athol, ID (US)

(72) Inventor: Troy Wayne Orcutt, Athol, ID (US)

(21) Appl. No.: 13/573,063

(22) Filed: Aug. 17, 2012

Related U.S. Application Data
(60) Provisional application No. 61/575,382, filed on Aug. 19, 2011.

(51) Int. Cl. F16B 43/00; B23P 11/00

(52) U.S. Cl. 29/525.11; 16/2.1

(57) ABSTRACT

An article of manufacture to retrofit a mounting bolt into an enlarged bracket bolt hole defined by an enlarged bracket bolt hole diameter in a mounting bracket includes a main body defined by a first side and a second side, a main body diameter, and a main body height. The article includes a hub extending from the second side of the main body, the hub being defined by a hub diameter and a hub height. The hub diameter is less than the main body diameter, and the hub diameter is selected to fit within the enlarged bracket bolt hole diameter and to provide a total clearance between the hub and the enlarged bracket bolt hole of less than 0.05 inches. The article further includes a bushing bolt hole opening defined through the main body and the hub, and a land defined on the first side of the main body.

### CROSS REFERENCE TO RELATED APPLICATIONS

This application claims priority to U.S. Provisional Patent Application Serial No. 61/575,382, filed Aug. 19, 2011, which is hereby incorporated by reference herein in its entirety.

### TECHNICAL FIELD

The disclosures provided herein relate to apparatus and methods to retrofit vehicle suspension component mountings and vehicle suspension enhancement component mountings.

### BACKGROUND

Many trucks in the U.S. which are classified by U.S. Department of Transportation Federal Highway Administration (FHWA) Vehicle Inventory and Use Survey (VIUS) standards for commercial truck classifications fall within the classification of medium to heavy duty trucks (i.e., trucks rated as three-quarter ton gross vehicle weight rating trucks up to trucks rated at about two tons gross vehicle weight rating—i.e., trucks rated as being in class 3 or 4, per the FHWA and VIUS). (Gross vehicle weight rating (also gross vehicle mass, GVWR, GVM) is the maximum operating weight/mass of a vehicle as specified by the manufacturer including the vehicle's chassis, body, engine, engine fluids, fuel, accessories, driver, passengers and cargo but excluding that of any trailers.) Common examples of current trucks that fall within this category are the Ford Motor Corporation model F250 and F350 trucks, the Dodge Ram® (a registered trademark of the Chrysler Group LLC) 2500 and 3500 trucks, and the General Motors Corp. (GMC) Sierra 2500HD pickup truck. (GMC does not appear to claim any trademark rights to the term “Sierra” as used for trucks, per the website http://www.gmc.com/sierra-2500hd-pickup-truck.html, at least as of Aug. 4, 2012. Accordingly, no acknowledgment for any trademark rights to the term “Sierra” as used for trucks is provided for herein.)

Many of the trucks which fall within the above described categories (generally, trucks in FHWA VIUS class 3 or 4, but not by limitation to the scope of the below-described invention) include four-wheel drive components. Four wheel drive (or 4WD) components includes a rear axle driven by a rear differential, and a front axle drive by a front differential. Each of these axle drives are typically accompanied by corresponding suspension enhancement components. Common examples of suspension enhancement components include: (1) traction arms to transfer axle-twist forces (which can be imparted to an axle by the drive train) to the frame of the vehicle; (2) anti-sway bars (or torsion bars) to transfer side loads during cornering to the opposite side suspension components; and (3) a panhard rod (or panhard bar) to keep the axle (typically, front axle) from moving side-to-side during cornering. With respect to the third component (i.e., a panhard bar), this component makes handling of the vehicle more predictable during turning. (The term “panhard”, as currently used herein, is deemed as being a generic derivative of the original suspension design by the Panhard automobile company of France in the early twentieth century.) A panhard bar is also frequently referred to as a panhard rod or a track bar. The panhard bar reduces lateral movement of the axle which can result from surface inputs (such as road surface irregularities). The panhard bar consists of a rigid bar running sideways in generally the same plane as the axle, and connected at a first end to one end of the axle (at a first side of the vehicle) and at a second end (at a second side of the vehicle) to the vehicle chassis. The panhard bar is attached on either end with pivots that permit it to swivel upwards and downwards only, so that the axle is allowed to move in the vertical plane only. Since this does not tend to locate the axle in a longitudinal direction, the panhard bar is typically used along with trailing arms which stabilize the axle in the longitudinal direction.

In general, most road-going vehicles (such as trucks and cars) employ suspension enhancement components (as described above). Further, most suspension enhancement components comprise a linkage (i.e., a suspension enhancement component linkage) which is pivotably connected (at least at a first or second end of the linkage) to the frame of the vehicle, or to a suspension component of the vehicle (such as an axle or a wheel supporting member). Further, most suspension enhancement components are supported to the frame of the vehicle, or to a suspension component of the vehicle (such as an axle), by a suspension enhancement component mounting bracket (to be referred to hereinafter generically as a mounting bracket). In certain applications the suspension enhancement component mounting brackets are subject to wear (as described below), and, over time, can allow for undesirable movement of the suspension enhancement component linkage with its connection to the vehicle frame and/or the vehicle suspension component to which it may also be mounted.

It is the object of the below described disclosure to provide apparatus and methods to address this problem of wear on suspension enhancement component mounting brackets.

### BRIEF DESCRIPTION OF THE DRAWINGS

Preferred forms, configurations, embodiments and/or diagrams relating to and helping to describe preferred aspects and versions of the inventions provided for herein are explained and characterized herein, often with reference to the accompanying drawings. The drawings, and all features shown therein, also serve as part of the disclosure of the inventions encompassed within the current document, whether described in text or merely by graphical disclosure alone. Such drawings are briefly described below.

FIG. 1 is a side view of a generic suspension enhancement component linkage, and specifically a torsion bar.

FIG. 2 is a plan view of the suspension enhancement component linkage of FIG. 1, as supported by suspension enhancement component brackets.

FIG. 2A is a plan view of an alternative suspension enhancement component mounting arrangement.

FIG. 3 is a side cross sectional view of the suspension enhancement component arrangement depicted in FIG. 2.

FIG. 4 is an end cross sectional view of the suspension enhancement component arrangement depicted in FIG. 2.

FIG. 5 is a partial oblique exploded view of the suspension enhancement component arrangement depicted in FIG. 2.

FIG. 6 is a front elevation view of another generic suspension enhancement component linkage, and specifically a panhard bar.

FIG. 7 is an oblique view of a vehicle suspension enhancement component mounting bracket depicting how an original bolt hole in the same can be enlarged in accordance with the current disclosures in order to accept a retrofit bushing further provided for by the current disclosures.

FIG. 8 is a an oblique view of another vehicle suspension enhancement component mounting bracket depicting how an original bolt hole in the same can be enlarged in accordance with the current disclosures in order to accept a retrofit bushing further provided for by the current disclosures.

FIG. 9 is a top plan view of a retrofit bushing according to the present disclosures for a vehicle suspension enhancement component mounting bracket.

FIG. 10 is a side view of the retrofit bushing of FIG. 9.

FIG. 11 is a bottom plan view of the retrofit bushing of FIG. 9

FIG. 12 is the same side view of the retrofit bushing of FIG. 9, but showing dimensional attributes of the bushing.

FIG. 13 is a side view of two of the retrofit bushings of FIGS. 10 and 12 in a mounting arrangement, and how they differ from the prior art mounting arrangement of FIG. 4.

FIG. 14 is a partial oblique exploded view of the suspension enhancement component arrangement depicted in FIG. 5, but showing how it differs from the prior art of FIG. 5 by application of the retrofit bushings of FIGS. 9-12.

### DETAILED DESCRIPTION

### Introductory Notes

The readers of this document should understand that the embodiments described herein may rely on terminology used in any section of this document and other terms readily apparent from the drawings and the language common therefor as may be known in a particular art, and such as known or indicated and provided by dictionaries. Dictionaries were used in the preparation of this document. Widely known and used in the preparation hereof are Webster's Third New International Dictionary (© 1993), The Oxford English Dictionary (Second Edition, © 1989), and The New Century Dictionary (© 2001-2005), all of which are hereby referenced for interpretation of terms used herein and for application and use of words defined in such references to more adequately or aptly describe various features, aspects and concepts shown or otherwise described herein using more appropriate words having meanings applicable to such features, aspects and concepts which are depicted or otherwise disclosed herein.

This document is premised upon using one or more terms with one embodiment that may also apply to other embodiments for similar structures, functions, features and aspects of the inventions. Wording used in the claims is also descriptive of the inventions, and the text and meaning of the claims and abstract are hereby-incorporated by reference into the description in their entirety as originally filed. Terminology used with one, some or all embodiments may be used for describing and defining the technology and exclusive rights associated herewith.

The readers of this document should further understand that the embodiments described herein may rely on terminology and features used in any suitable section or other embodiments shown in this document and other terms readily apparent from the drawings and language common or proper therefor. This document is premised upon using one or more terms or features shown in one embodiment that may also apply to or be combined with other embodiments for similar structures, functions, features and aspects of the inventions and provide additional embodiments of the inventions.

The invention(s) provided for by this disclosure may include a number of different specific configurations, embodiments, and/or variations, some or all having different advantages or effects relative to features, operation and production.

Features shown on some of the illustrated and/or described versions may also be used on other embodiments if aspects of construction and use do not prevent such added configurations from being implemented according to this disclosure.

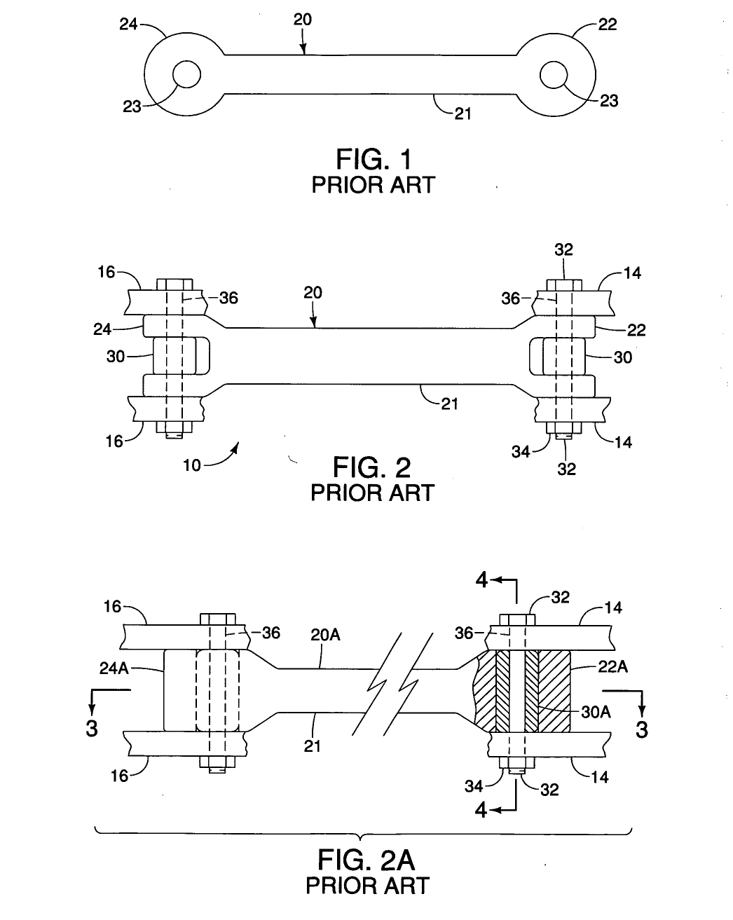

Turning now to FIG. 1 a prior art suspension enhancement component 20 is shown in a side view. In this instance the suspension enhancement component 20 is a traction bar having an elongate main body portion 20 and respective first and second knuckle ends 22 and 24. The knuckle ends 22 and 24 include bolt holes 23 to allow the traction bar to be mounted to a vehicle.

Turning now to FIG. 2, the torsion bar 20 of FIG. 1 is shown in plan view in a mounted configuration. Specifically, the knuckle end 22 of the torsion bar 20 is supported between parallel plates 14 of a first suspension enhancement component bracket, while the knuckle end 24 of the torsion bar is supported between parallel plates 16 of a second suspension enhancement component bracket. A bearing 30 fits between the forked ends of knuckles 22 and 24. Bolts 32 (secured by nuts 34) pass through bracket bolt holes 36 in the parallel bracket plates 14 and 16, as well as through bolt holes 23 in knuckles 22 and 24, and bearing 30. An alternative configuration of the suspension enhancement component bracket of FIG. 2 is depicted in FIG. 2A wherein the torsion bar 20A has hollow end knuckles 22A and 24A (versus the forked knuckles 22 and 24 of FIG. 2). In the arrangement of FIG. 2A the torsion bar 20A has a bearing hole (not numbered) disposed in each knuckle 22A, 24A such that the bearings 30A can be inserted into the bearing holes. As with the arrangement depicted in FIG. 2, in FIG. 2A the torsion bar is held in place between parallel plates 14 and 16 of respective first and second mounting brackets. The bolt 32 is then passed through the bracket bolt holes 36 in the parallel plates 14 and 16. The knuckles 22A and 24A thus define mounting ends of the component arm 20A.

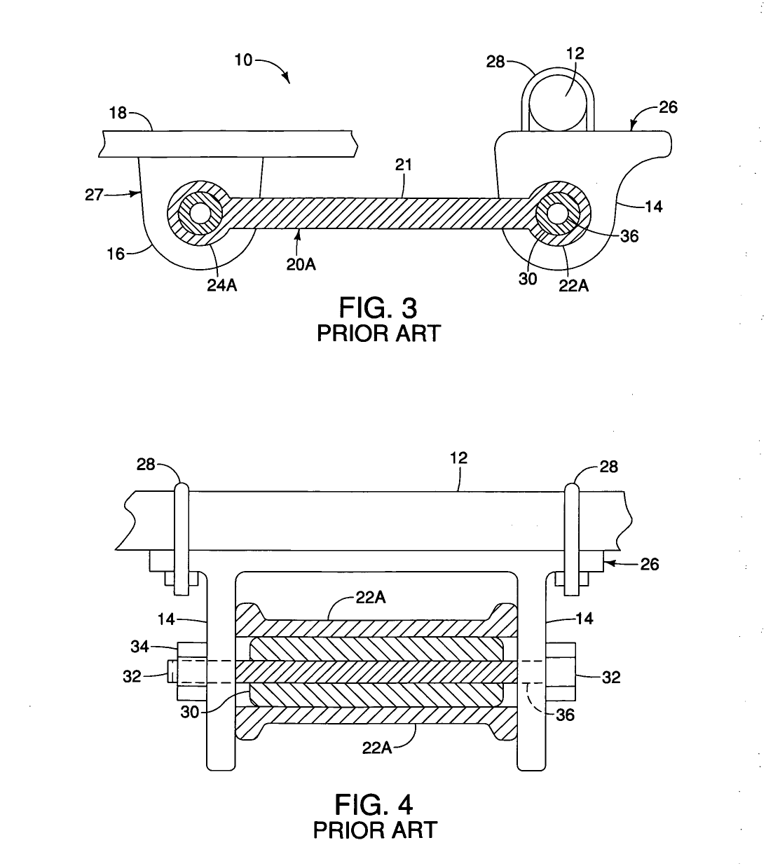

Turning now to FIG. 3, a cross sectional side view of the arrangement depicted in FIG. 2A is shown. In this example first suspension enhancement component bracket 26 (or first bracket, as it will be referred to herein) is held fast against an axle 12 by u-bolts 28, and second suspension enhancement component bracket 26 (or second bracket, as it will be referred to herein) is held fast against chassis frame member 18 (such as by welding or bolting). FIG. 4 is a cross sectional end view of the first end member (or knuckle) 22A of FIG. 2A, depicting how the bearing 30 resides within the bearing opening (not numbered) of the end 22A, and how the bolt 32 passes through the parallel plates 14 of first bracket 26 and bearing 30, and is secured thereto by nut 32.

FIG. 5 is an oblique exploded view depicting another configuration of a first suspension enhancement component bracket 40 (similar to first bracket 26 of FIG. 3) and torsion bar 20A, and showing how the bearing 30 nests within the bearing opening (not numbered) in the first end 22A of the torsion bar, how the first end 22A of the torsion bar nests between the parallel plates 14 of the first bracket 40, and how the bolt 32 passes through the bracket bolt holes 36 in the parallel plates 14 and engages with nut 34 to thus secure the first end 22A of the torsion bar 20A between the parallel plates 14. As can be appreciated from FIGS. 3 and 5 (a common torsion bar mounting configuration), all of the forces applied by the axle 12 to the first end 22A of the torsion bar are ultimately borne by the bolt 32 acting against the bracket bolt holes 36. In certain applications the first bracket 40 (FIG. 5) is formed from stamped carbon steel sheet metal of a thickness of approximately ⅛ inch, and the bracket bolt hole 36 is approximately ⅜ inch in diameter. (In practice, the bracket bolt hole 36 is slightly larger than ⅜ inch in diameter in order to accommodate a nominal ⅜ inch diameter bolt.) Further, the torsion bar mounting configuration depicted in FIG. 5 has been frequently used for mounting torsion bars to medium to heavy duty trucks. Such medium to heavy duty trucks are frequently provided with diesel engines having high torque ratings—e.g., 500-600 ft-lb of torque. Thus, as can be appreciated from the above, during acceleration a large amount of pressure can be applied against the rear edge (i.e., the edge facing away from the second bracket 27 in FIG. 3) of the bracket bolt hole 36 of first bracket 40. (Likewise, assuming essentially identical bolt and bolt hole diameters for the second bracket 27, FIG. 3, the same pressure is applied to these components in the opposite direction.) Since the bolts 32 are typically fabricated from a higher strength steel than are the brackets 26, 27 (FIGS. 3) and 40 (FIG. 5), over time the pressures applied to the bracket bolt holes 36 by the bolts 32 will tend to wear away metal from around the bolt holes, thus enlarging the bolt holes (as described above in the Background section).

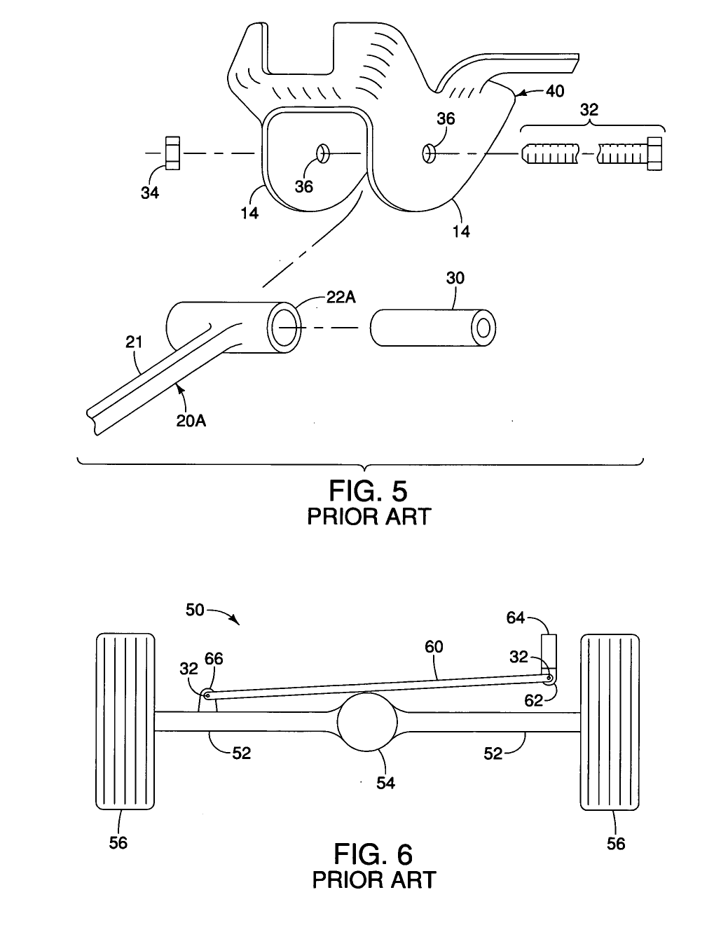

Turning now to FIG. 6 a second exemplary suspension enhancement component mounting arrangement 50 is depicted. FIG. 6 is a diagrammatic front view of a panhard rod 60 (also frequently known as a track bar) mounted to a vehicle front suspension. In this example the front suspension is depicted as being a front axle 52 (as in a common 4-wheel drive medium to heavy duty truck) which drives tires 56 by virtue of a front axle 54. The panhard rod includes a first end (not numbered) mounted to the vehicle frame 64 by a first mounting bracket 62, and a second end (not numbered) mounted to the front suspension (here, axle 52) by a second mounting bracket 66. More specifically, the first and second ends of the panhard rod 60 are mounted to the first and second brackets (62, 66) by bolts 32 (which can be similar to bolts 32 of FIGS. 2-5). As with brackets 26 and 27 of FIG. 3 (and bracket 40 of FIG. 5), the bolt holes (not shown or numbered) for brackets 62 and 66 of FIG. 6 are also subject to wear (and thus enlargement) from bolts 32 due to repeated sideways application of forces whenever the wheels 56 are turned or move in a vertical direction. In the case of the track arm 60, enlargement of the bolt holes in the mounting brackets 62 and 66 can cause steering lash and other undesirable effects. Since the suspension enhancement component brackets are oftentimes welded to mounting points (such as the frame of the vehicle), it can be very difficult and costly to replace the worn brackets with replacement brackets. Further, replacement suspension enhancement component brackets are frequently not available as after-market components which can be purchased. Accordingly, it is desirable to find a solution to the problem of bolt-hole wear in suspension enhancement component brackets. To this end, I have developed a solution to this problem, as more particularly described below.

I have discovered that by enlarging the bolt hole in a suspension enhancement component bracket, and then inserting a bushing (described more particularly below) into the enlarged bolt holt, wear on the enlarged bolt hole can be significantly reduced over the wear experienced by the original bolt hole. Preferably, the bushing is fabricated from a material having a greater hardness than the material from which the suspension enhancement component bracket is fabricated.

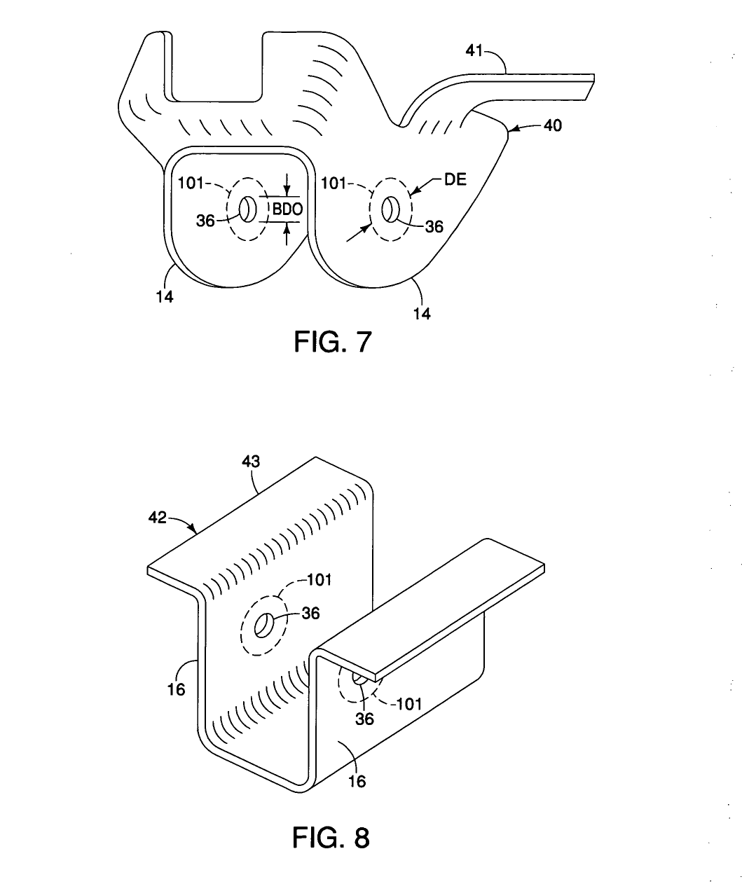

Turning briefly to FIG. 7, the suspension enhancement component bracket 40 of FIG. 5 is shown (including mounting feature 41 which can be used to secure the bracket 40 to a frame member or the like by means such as bolts, screws, and/or welds). For my discovery, the original bracket bolt holes 36 (defined by an original bracket bolt hole opening diameter, or bracket-bolt-hole-diameter-original-opening—or “BDO” as per FIG. 7, being the diameter of the bracket bolt hole openings 36 as originally formed in the bracket 40 prior to any wear) are enlarged to the greater diameter of the enlarged bracket bolt holes 101 (shown in dashed lines). (According to my discoveries, this enlargement of the bracket bolt holes 36 to the greater diameter of enlarged bracket bolt holes 101 can be performed at any time—i.e., prior to or subsequent to any wear of the original bracket bolt holes 36.)

Another such suspension enhancement component bracket 42 is depicted in FIG. 8. Bracket 42 of FIG. 8 includes parallel plates 16 (similar to bracket 27 of FIG. 3), and mounting flanges 43 which can be attached to a frame member or a suspension member by means such as bolting or welding (by way of example only). In the instance of FIG. 8, original bolt holes 36 can be enlarged to the greater diameter of the bracket bolt holes 101 (shown in dashed lines). The enlarged bracket bolt holes 101 are defined by defined by enlarged bracket bolt hole diameters DE (FIG. 7).

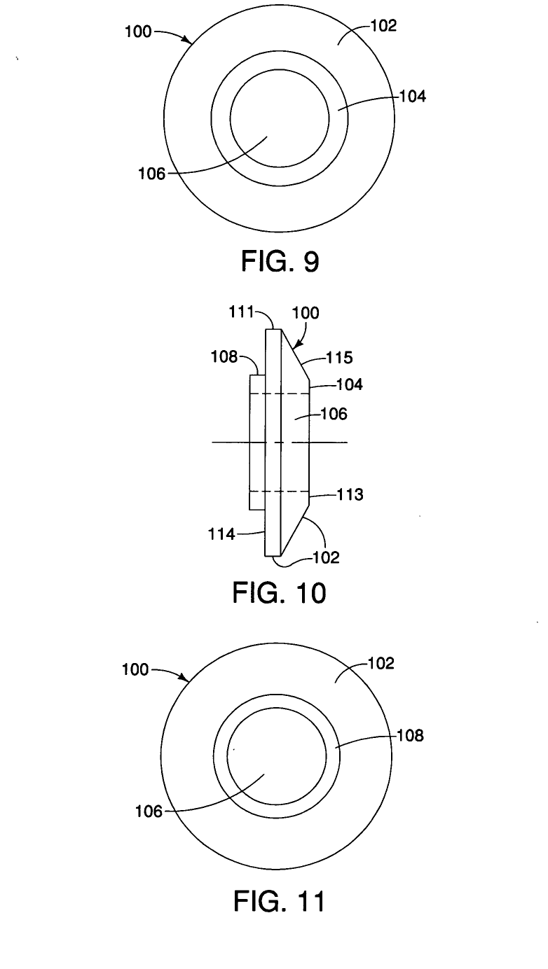

Turning now to FIGS. 9-11, respective top, side and bottom views of a retrofit bushing 100 in accordance with the present disclosure are shown. The retrofit bushing 100 is preferably circular in shape (as viewed from the top and bottom) and includes a main body portion 102 defined by a first side 113 and a second side 114. The bushing 100 further includes a hub 108 which extends from the second side 114 of the main body 102. The hub 108 is preferably circular in shape in the bottom view (FIG. 11) and is further preferably concentric with the main body 102. The bushing 100 includes a bushing bolt hole opening 106 defined through the main body 102 and the hub 108, the bushing bolt opening 106 being preferably circular in top view (FIG. 9) and concentric with the main body and hub. The bushing 100 defines a land 104 defined on the first side 113 of the main body 102. As shown in FIGS. 10 and 11, the land is preferably circular in shape, concentric with the main body 102, and of a smaller diameter than the main body portion. More preferably, the diameter of the land 104 is selected to allow a bolt head or a washer to engage the land to secure the bushing 100 into the enlarged bracket bolt holes (101, FIG. 7) of the suspension enhancement component brackets (40, 43). Since the land 104 is of a smaller diameter than the main body 102 of the bushing, the first side 113 of the main body forms a truncated cone shape when viewed from the side (FIG. 10). The main body 102 can thus comprise two segments: a first cylindrical segment 111 (FIG. 10) having the second side 114 of the main body as a outward facing surface, and the second truncated conical segment 115 having the first side 113 of the main body as a outward facing surface.

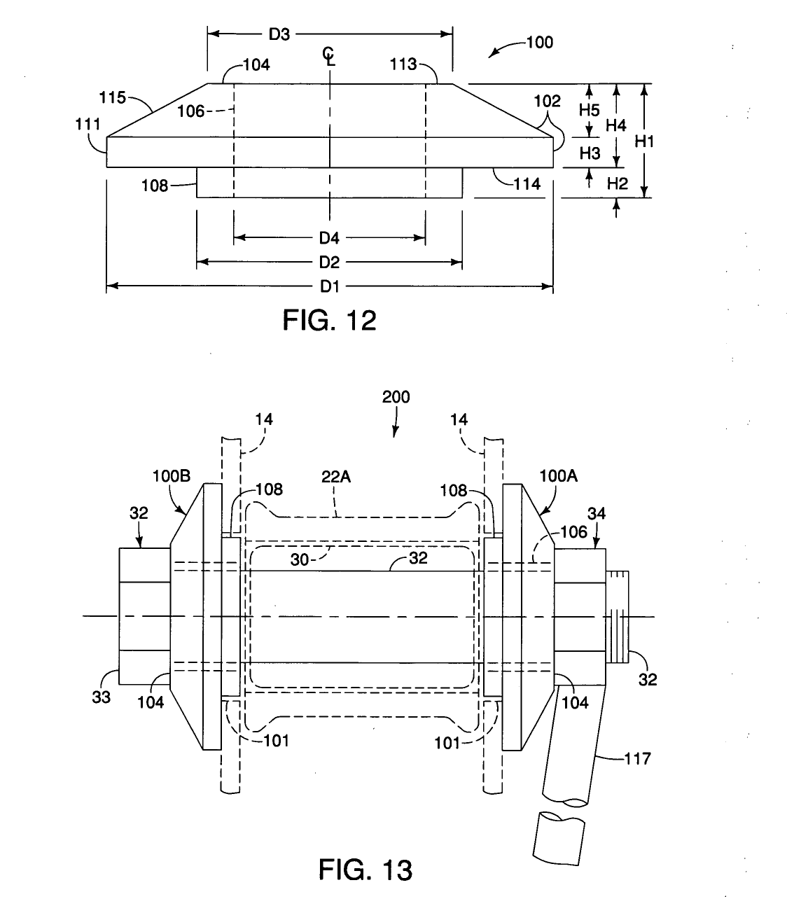

Turning now to FIG. 12, the bushing 100 is shown in the side view of FIG. 10, but with dimensional lines added to assist in defining the bushing 100. Thus, the main body 102 of the bushing 100 is defined by a main body diameter D1 and a main body height H4. Main body height H4 is the sum of the cylindrical segment 111 height H3 and the truncated conical section 115 height H5. The land 104 is defined by a land diameter D3. The hub 108 is defined by a hub diameter D2 and a hub height H2. The bushing bolt hole opening 106 is defined by a bolt hole diameter D4, and the length (or height) of the bushing bolt hole 106 is the height H1 of the overall bushing 100. Preferably the main body diameter D1 is at least 2.5 times the bolt hole opening (or bushing bolt hole opening) diameter D4, and the hub diameter D2 is at least 1.7 times the bushing bushing bolt hole opening diameter D4. These ratios provide for a sufficiently enlarged bolt hole opening 101 (FIG. 7) to substantially reduce future wear of the enlarged bolt hole opening when the hub 108 of the bushing 100 is placed within the enlarged opening 101. Further, preferably the hub height H2 is selected to be essentially the same as the thickness of the parallel plates 14, 16 (FIG. 2). For example, if the bracket is fabricated from sheet metal having a nominal thickness of ⅛ inch, then the hub height H2 is selected to be ⅛ inches (0.125 inches). This ensures that the hub 108 does not protrude into the area between the parallel plates (14, 16) and possibly interfere with the articulation of the ends 22A, 24A of the suspension enhancement component 20A which are located between between the parallel plates.

In one representative example wherein the bushing is configured for use with a bolt 32 (FIG. 4) having a nominal bolt diameter of 9/16 inches, exemplary dimensions for the bushing 100 are as follows: a main body diameter D1 of 1.5 inches; a hub diameter D2 of 1.0 inch; a bolt hole opening diameter D4 of 0.5625 inches; a land diameter D3 of 0.825 inches; an overall bushing height H1 of 0.45 inches; a hub height H2 of 0.125 inches; a cylindrical body segment height of 0.125 inches; and a truncated conical segment height of 0.20 inches.

Although not shown, the bushing bolt hole opening 106 can include chamfers at one or both of the ends of the opening, and the hub 108 can include a chamfer at its distal end. The chamfers facilitate inserting a bolt into the opening 106, and inserting the hub 108 into the enlarged bolt hole 101. Also, it will be appreciated that the truncated conical segment 115 can be eliminated and the cylindrical segment 111 extended in length (height).

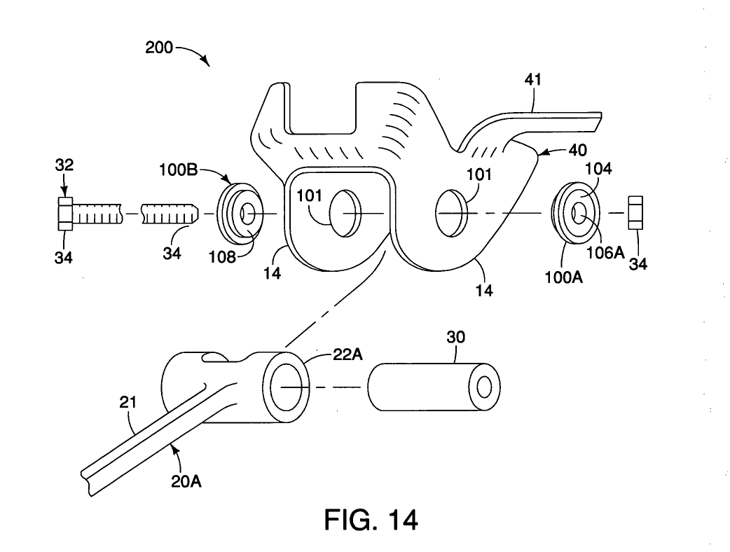

Turning now to FIG. 13, an end view of two of the retrofit bushings 100 of FIGS. 10-12 are depicted in a mounting arrangement 200. FIG. 13 should be compared against the similar prior art view of FIG. 4 to appreciate how a mounting arrangement of the bushings 100 differs from the prior art. Specifically, the mounting arrangement 200 of FIG. 13 includes a first bushing 100A and a second bushing 100B. The bushings 100A and 100B are positioned in opposite directions from one another, with the hubs 108 facing towards one another. More specifically, each hub 108 is positioned within an enlarged bracket bolt hole 101 formed in the parallel plates 14 (see FIG. 14) of a suspension enhancement component mounting bracket (e.g., bracket 40, FIG. 14). Positioned between the parallel plates 14 is an end knuckle 22A (see FIGS. 3 and 4) of a suspension enhancement component, and positioned within a bearing opening (not numbered) in knuckle 22A is a bearing 30. (End knuckle 22A and bearing 30 are shown in pantom lines.) A bolt 32 passes through the assembly of the bushings 100A and 100B, the parallel plates 14, and the bearing 30. The bolt 30 includes a bolt head 33 which rests against the land 104 of the second bushing 100B. A nut 34 is threaded onto the second end (not numbered) of the bolt 32 where the bolt extends from the bushing bolt opening 106 in the first bushing 100A. The nut rests against the land 104 of the second bushing 100B. (It will be appreciated that the direction of inserting the bolt 32 into the assembly is not relevant other than for convenience of assembly to the user.) In the example depicted in FIG. 13, a nut handle 117 is attached to the nut 34. The nut handle can facilitate tightening the nut in hard-to-reach locations. In one example the nut handle can be steel bar stock welded to the nut 34.

In FIG. 14 a partial exploded view of the suspension enhancement component arrangement 200 depicted in FIG. 14 is shown in an oblique view. A comparison of FIG. 14 to the similar prior art view of FIG. 5 should be made to appreciate the differences. Specifically, with respect to FIG. 14, the mounting configuration for the suspension component enhancement member 20A is enhanced by the inclusion of the retrofit bushings 100 of FIGS. 9-12. As can be seen, for assembly of the arrangement 200 first bushing 100A is placed into the enlarged bracket bolt hole 101 in plate 14 of mounting bracket 40, and second bushing 100B is placed into the enlarged bracket bolt hole 101 in the other plate 14 of the mounting bracket. Bearing 30 is then inserted into the bearing opening (not numbered) in knuckle 22A of the suspension enhancement component 20A, and the knuckle 22A is then positioned between the parallel plates 14. Bolt 32 is then passed into the second bushing 100B, through the bearing 30, and on through the first bushing 100A. Nut 34 is then used to secure all of the components in place.

The present disclosure thus provides for a retrofit bushing 100 (FIGS. 9-12), a retrofit kit (as indicated by FIGS. 13 and 14), and a method of retrofitting a bolt into a mounting bracket having an original bracket bolt hole (36, FIG. 5) defined by an original bolt hole opening diameter. The method includes the following steps. First, the existing bolt 32 (FIG. 5) holding the suspension enhancement component (e.g., 20A) into the mounting bracket (40) is removed from the original the bracket bolt holes 36, thus allowing the suspension enhancement component to be removed from the bracket. Next, the original bracket bolt holes 36 are enlarged to a new expanded bracket bolt hole diameter (DE, FIG. 7) thus creating enlarged bracket bolt holes 101 (FIG. 14). The enlargement of the bracket bolt hole 36 to the enlarged size hole 101 is preferably performed by drilling or the like to ensure a regular circular shape. Preferably, the expanded bracket bolt hole diameter (DE, FIG. 7) is sized to be essentially the same (but not smaller) than the diameter D2 (FIG. 12) of the hub 108 of the bushing 100. More preferably, the total clearance between the hub 108 and the enlarged bracket bolt hole 101 is less than 0.05 inches. Next, bushings 100 are inserted into the enlarged bracket bolt holes 101. More specifically, the hub 108 (FIG. 12) of each bushing 100 is inserted into the enlarged bracket bolt holes 101 with the bushings 100 being located on the outside of the parallel plates 14 (FIGS. 13 & 14). Since the bushing 100 (and specifically, the hub 108 of the bushing) is preferably fabricated from a metal having a greater hardness than the metal from which the bracket 40 is fabricated, the hub of the bushing can be pressed or otherwise urged (such as by hammering) into the enlarged bracket bolt holes 101. Providing a press fit between the hub 108 and the enlarged bracket bolt holes 101 essentially prevents lash between the hub and the enlarged bolt hole 101, thus reducing future wear on the edges of the enlarged bolt holes. Next, the knuckle 22A (FIG. 14) of the suspension enhancement component (e.g., 20A) is placed back in position between the parallel plates 14 of the bracket, and a bolt (32) is then passed through the bushing bolt hole opening 106 (FIGS. 9-11) of the second bushing 1006, through the knuckle 22A (or a bearing 30 inserted into the knuckle), and on through the bushing bolt hole opening 106 of the first bushing 100A. The bolt 32 is then secured in place by nut 34, thus holding the whole assembly (200, FIG. 13) in place.

Preferably, in the method the original bolt used in the assembly is replaced with a new bolt. The new bolt is preferably of the same diameter as the original bolt to ensure fitting through existing bolt hole openings in the bearing (30). The reasons for preferably using a new bolt in the retrofit method are as follows: old bolts may exhibit wear and thus present undesirable lash to the retrofit mounting arrangement; new bolts can be selected to be of a length selected to accommodate the additional length required by the addition of the bushings 100 to the mounting configuration (specifically, the bushing body height H4, FIG. 12, which extends outside of each bracket plate 14); new bolts can be selected to be of a material hardness essentially the same as the material hardness of the bushing (thus reducing wear on the bushing); and new bolts will generally provide a more secure fastening due to the general absence of rust and/or dirt on the new bolt. In one variation the material hardness of the new bolt can be selected to be slightly less than the material hardness of the bushing. In this way any wear will be experienced by the bolt and not the bushing, and the bushing will not need to be replaced due to future wear in the mounting configuration. (As can be appreciated, subsequent retrofitting of a retrofit busing will require further expanding the diameter of the enlarged bracket bolt hole 101, and at some point the mounting bracket may not be able to accommodate further enlargement of the bracket bolt hole without compromising the integrity of the bracket.) Also preferably in the method the original nut used in the assembly is replaced with a new nut. The reasons for using a new nut mirror many of the reasons articulated above for using a new bolt (e.g., elimination of existing wear, reduction of foreign matter which can affect fit, and material selection properties).

In certain applications the method can include providing a new bolt having a larger diameter bolt than the original bolt. This step can be used where the knuckle 22A and/or the bearing 30 (FIG. 14) can accommodate the larger diameter bolt. The advantage of using a larger diameter new bolt in the retrofit method and mounting arrangement is that a larger diameter bolt will distribute applied forces over a larger surface area than the original bolt, thus reducing wear on the mounting components (i.e., hub 108 of bushing 100, bracket plate 14, and the bolt 34 itself).

It will be understood that the method can also be used where only a single bracket plate is present in a particular bracket. For example, if a mounting allows for the threaded end of the bolt to be received by a threaded bolt hole mounted on the vehicle, then only one retrofit bushing 100 will be required in order to perform the retrofit method. It will also be understood that the method of the present disclosure can be practiced on vehicle mountings (as well as other mountings, such as industrial applications) which do not involve vehicle suspension enhancement components.

As indicated above, a kit for retrofit mounting of an original bolt to a suspension enhancement component bracket is included within the scope of the present disclosure. The retrofit kit can include two of the retrofit bushings 100 (FIGS. 9-14), a new bolt selected to accommodate the added height (length) dimension added to the mounting configuration by the two bushing body heights (as discussed above), and a new nut. The retrofit kit can further include instructions for retrofitting the existing mounting configuration using the bushings 100 of the present disclosure, and in particular, instructions for selecting the proper enlarged diameter DE (FIG. 7) of the original bracket bolt hole (36) to the enlarged diameter bracket bolt hole (101) in order to accommodate the bushings 100 provided with the kit. The retrofit kit can also include lock washers (not shown in the drawings, but understood to those of skill in the art) which can be placed between (i) the nut 34 (FIG. 14) and the land 104 of a bushing 100, and/or (ii) the head 34 of the bolt 32 and the land 104 of a bushing.

I claim:

1. An article of manufacture configured to retrofit a mounting bolt into an enlarged bracket bolt hole defined by an enlarged bracket bolt hole diameter in a mounting bracket, comprising:
a main body defined by a first side and a second side, a main body diameter, and a main body height;
a hub extending from the second side of the main body, the hub being defined by a hub diameter and a hub height, and wherein the hub diameter is less than the main body diameter, and the hub diameter is selected to fit within the enlarged bracket bolt hole diameter and to provide a total clearance between the hub and the enlarged bracket bolt hole of less than 0.05 inches;
a bushing bolt hole opening defined through the main body and the hub; and
a land defined on the first side of the main body, the land configured to mate with one of a bolt head of a bolt configured to pass through the bushing bolt hole opening, or a nut configured to mate with the bolt configured to pass through the bushing bolt hole opening.

2. The article of manufacture of claim 1 and wherein the diameter of the land is less than the main body diameter.

3. The article of manufacture of claim 2 and wherein the main body comprises:
a cylindrical segment defined by a cylindrical segment height and having as an outward surface the second side of the main body; and
a truncated conical segment defined by a truncated conical segment height and having as an outward facing surface the land.

4. The article of manufacture of claim 1 and wherein the article of manufacture is fabricated from a first material defined by a first material hardness which is greater than a second material hardness, the second material hardness defining a second material from which the mounting bracket is fabricated.

5. The article of manufacture of claim 1 and wherein the bushing bolt hole is defined by a bushing bolt hole diameter, and the main body diameter is at least 2.5 times the bushing bolt hole diameter.

6. The article of manufacture of claim 1 and wherein the bushing bolt hole is defined by a bushing bolt hole diameter, and the hub diameter is at least 1.7 times the bushing bolt hole diameter.

7. The article of manufacture of claim 1 and wherein the mounting bracket is defined by a nonimal bracket thickness, and the hub height is essentially the same as the nonimal bracket thickness.

8. The article of manufacture of claim 1 and wherein the main body, the hub, the bushing bolt hole and the land are all concentric about a common centerline.

9. A method to retrofit a bolt into a mounting bracket having an original bracket bolt hole defined by an original bracket bolt hole opening diameter, comprising:
enlarging the original bracket bolt hole opening diameter in the mounting bracket to an enlarged bracket bolt hole diameter;
providing an article of manufacture according to claim 1;
fitting the hub of the article of manufacture according to claim 1 within the enlarged bracket bolt hole diameter; and
securing the bolt to (i) the article of manufacture according to claim 1, and (ii) the mounting bracket.

10. The method of claim 9 and wherein:
the mounting bracket includes first and second essentially parallel plates, and wherein the original bracket bolt hole is a first original bracket bolt hole formed in the first plate, and a second original bracket bolt hole is formed in the second plate;
the article of manufacture provided according to claim 1 is a first retrofit bushing;
the enlarged bracket bolt hole diameter in the bracket is a first enlarged bracket bolt hole diameter in the bracket;
the hub of the first retrofit bushing is a first retrofit bushing hub;
the method further comprising:
providing a second retrofit bushing according to claim 1, the second retrofit bushing having a second retrofit bushing hub;
enlarging the second original bracket bolt hole opening diameter in the second plate to the enlarged bracket bolt hole diameter in order to form a second enlarged bracket bolt hole;
fitting the second retrofit bushing hub into the second enlarged bracket bolt hole such that the first and second bushing hubs are facing one another, and the first and second bushing main bodies are supported on opposite outward facing surfaces of the essentially parallel first and second plates;
placing a mounting end of a component arm between the first and second plates;
passing the bolt through the bushing bolt openings defined in the first and second retrofit bushings;
providing a nut; and
using the nut to secure the bolt in place to thereby capture the first and second retrofit bushings on the outward facing surfaces of the essentially parallel first and second plates, and the mounting end of the component arm between the essentially parallel first and second plates.

11. The method of claim 10 and further comprising using a new bolt as the bolt.

12. An apparatus comprising a kit for retrofitting an original bolt into a mounting bracket having an original bracket bolt hole defined by an original bracket bolt hole opening diameter, the kit comprising:
first and second articles of manufacture according to claim 1;
a new bolt to replace the original bolt; and
instructions for a user of the kit, the instructions including recommendations for enlarging the original bracket bolt hole opening diameter to an enlarged bracket bolt hole opening diameter in order for the enlarged bracket bolt hole opening diameter to accommodate the hub diameter of the hub of the article of manufacture according to claim 1.

13. The kit of claim 12 and wherein the original bolt is defined by an original bolt length, the new bolt is defined by a new bolt length, and the new bolt length is greater than the original bolt length by at least twice the main body height of the main body of the article of manufacture.

14. The kit of claim 12 and further comprising a new nut to replace an original nut which was used to secure the original bolt to the mounting bracket.
